(19) United States
(12) Patent Application Publication
(10) Pub. No.: US 2015/0264071 A1
(43) Pub. Date: Sep. 17, 2015

(54) ANALYSIS SYSTEM AND ANALYSIS APPARATUS

(71) Applicants: KABUSHIKI KAISHA TOSHIBA, Minato-ku (JP); TOSHIBA SOLUTIONS CORPORATION, Kawasaki-shi (JP)

(72) Inventors: Kenji KOJIMA, Kawasaki (JP); Michiyo IKEGAMI, Fuchu (JP)

(73) Assignees: KABUSHIKI KAISHA TOSHIBA, Minato-ku (JP); TOSHIBA SOLUTIONS CORPORATION, Kawasaki-shi (JP)

(21) Appl. No.: 14/645,696

(22) Filed: Mar. 12, 2015

(30) Foreign Application Priority Data
Mar. 12, 2014 (JP) 2014-048938

(51) Int. Cl. H04L 29/06

(52) U.S. Cl. CPC H04L 63/1416; H04L 63/0263; H04L 63/02

(57) ABSTRACT

In general, according to one embodiment, an analysis system includes a sampling device disposed in a monitoring-target system. The analysis apparatus is configured to analyze a possibility of occurrence of a security incident, based on communication data sampled by the sampling device. The sampling device includes a transmission unit configured to transmit sample data meeting a rule of data sampling to the analysis apparatus, and a sampling rule setting unit configured to set the rule in accordance with an instruction from the analysis apparatus. The analysis apparatus includes a sampling rule management unit configured to instruct the sampling device to change the rule in accordance with a result of an analysis of the sample data.

### CROSS REFERENCE TO RELATED APPLICATIONS

This application is based upon and claims the benefit of priority from Japanese Patent Application No. 2014-048938, filed Mar. 12, 2014, the entire contents of which are incorporated herein by reference.

### FIELD

Embodiments described herein relate generally to an analysis system, an analysis apparatus and an analysis program, which collect, from a monitoring-target system, log data and communication data relating to the operation of the system, and detect a security incident such as an attack from the outside by using the collected information, thus making an analysis for securing monitoring.

### BACKGROUND

There is known an analysis system as a system for system monitoring, which aims at detecting a security incident such as an attack from the outside. The analysis system gathers communication data and log data on a monitoring-target system into one location, and detects an incident by analyzing such data. In this system, a plurality of sampling devices for collecting communication data and log data are disposed in a system which is a monitoring target, and the data is collected in an analysis apparatus, which is provided on the cloud or the like, from the sampling devices. The analysis apparatus detects a symptom or occurrence of a security incident with respect to the data collected by the sampling devices, based on predetermined rules for a security incident analysis.

In order to efficiently detect a security incident by an analysis of communication data, it is desirable to provide sampling devices of communication data at a plurality of locations within the monitoring-target system. Specifically, it is desirable to gather data in the analysis apparatus from many multiple locations within the monitoring-target system, and to make an analysis by associating the data. In this case, however, there is such a problem that, since the data is gathered in the analysis apparatus from many locations, the traffic to the analysis apparatus and the processing amount in the analysis apparatus become enormous.

Conversely, when the number of locations, where the sampling devices are disposed, is decreased, the collected data amount decreases, so there is no problem with the traffic or processing amount. However, the amount of data for use in an analysis decreases. It is thus difficult to efficiently detect an incident.

### BRIEF DESCRIPTION OF THE DRAWINGS

FIG. 1 is an exemplary functional block diagram illustrating a functional configuration of a communication data analysis system according to an embodiment.

FIG. 2 is an exemplary block diagram illustrating a detailed functional configuration of an analysis apparatus and a sampling device of the communication data analysis system in the embodiment.

FIG. 3 is a view illustrating an example of disposition of the sampling device in the embodiment.

FIG. 4 is a view illustrating an example of disposition of the sampling device in the embodiment.

FIG. 5 is an exemplary flowchart illustrating an operation of the analysis apparatus in the embodiment.

FIG. 6 is a view illustrating a concrete example of sampling rules which are set in a sampling device in a first embodiment.

FIG. 7 is a view illustrating a concrete example of sampling rules which are set in the sampling device in the first embodiment.

FIG. 8 is a view illustrating a concrete example of sampling rules which are set in a sampling device in a second embodiment.

FIG. 9 is a view illustrating a concrete example of sampling rules which are set in the sampling device in the second embodiment.

### DETAILED DESCRIPTION

In general, according to one embodiment, an analysis system includes a sampling device disposed in a network in a monitoring-target system. The analysis apparatus is configured to analyze a possibility of occurrence of a security incident, based on communication data sampled by the sampling device. The sampling device includes a transmission unit configured to transmit sample data meeting a rule of data sampling, among the communication data of the network, to the analysis apparatus, and a sampling rule setting unit configured to set the rule in accordance with an instruction from the analysis apparatus. The analysis apparatus includes a sampling rule management unit configured to instruct the sampling device to change the rule in accordance with an analysis result, when it is determined that there is the possibility of occurrence of a security incident, as a result of an analysis of the sample data transmitted by the transmission unit.

Various embodiments will be described hereinafter with reference to the accompanying drawings.

### First Embodiment

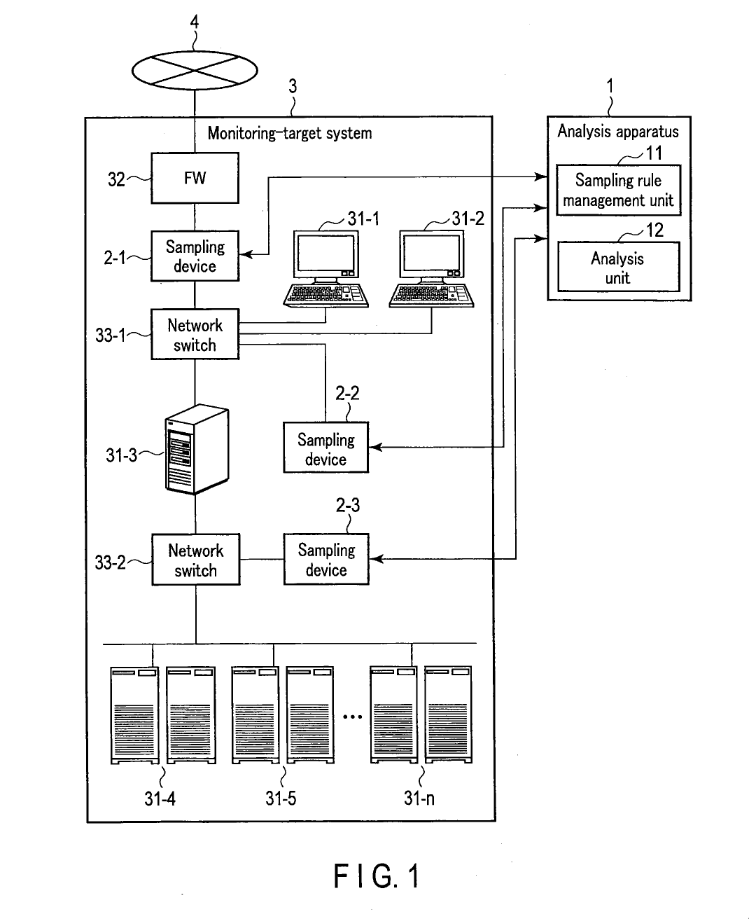

FIG. 1 is an exemplary functional block diagram illustrating a functional configuration of a communication data analysis system which is common to the embodiments. As illustrated in FIG. 1, the communication data analysis system includes an analysis apparatus 1, and a plurality of sampling devices 2 (in FIG. 1, three sampling devices 2-1, 2-2 and 2-3 are illustrated) which are disposed in a network in a monitoring-target system 3.

The analysis apparatus 1 includes an analysis unit 12 which receives communication data (sample data) sampled by the sampling devices in the monitoring-target system 3, and analyzes the possibility of a security incident by using the sample data. The analysis apparatus 1 also includes a sampling rule management unit 11. As a result of an analysis of the sample data by the analysis unit 12, if it is determined that there is a possibility of occurrence of a security incident, the sampling rule management unit 11 instructs, in accordance with the analysis result, the sampling devices 2 to change sampling rules for acquiring communication data and transmitting the communication data to the analysis apparatus 1.

The monitoring-target system 3 is configured such that a plurality of information devices (31-1, 31-2, 31-3, 31-4, 31-5, . . . , 31-n) including, for example, a server, a database and a terminal device (personal computer) are connected over a network. The monitoring-target system 3 is connected to an external network 4 including, for example, the Internet, and transmits/receives data to/from the external network 4 through a firewall (FW) 32. In addition, in the monitoring-target system 3, a plurality of network switches 33 (in FIG. 1, two network switches 33-1 and 33-2 are illustrated) are provided in the network. A plurality of information devices 31 are connected to each of the plural network switches 33-1 and 33-2.

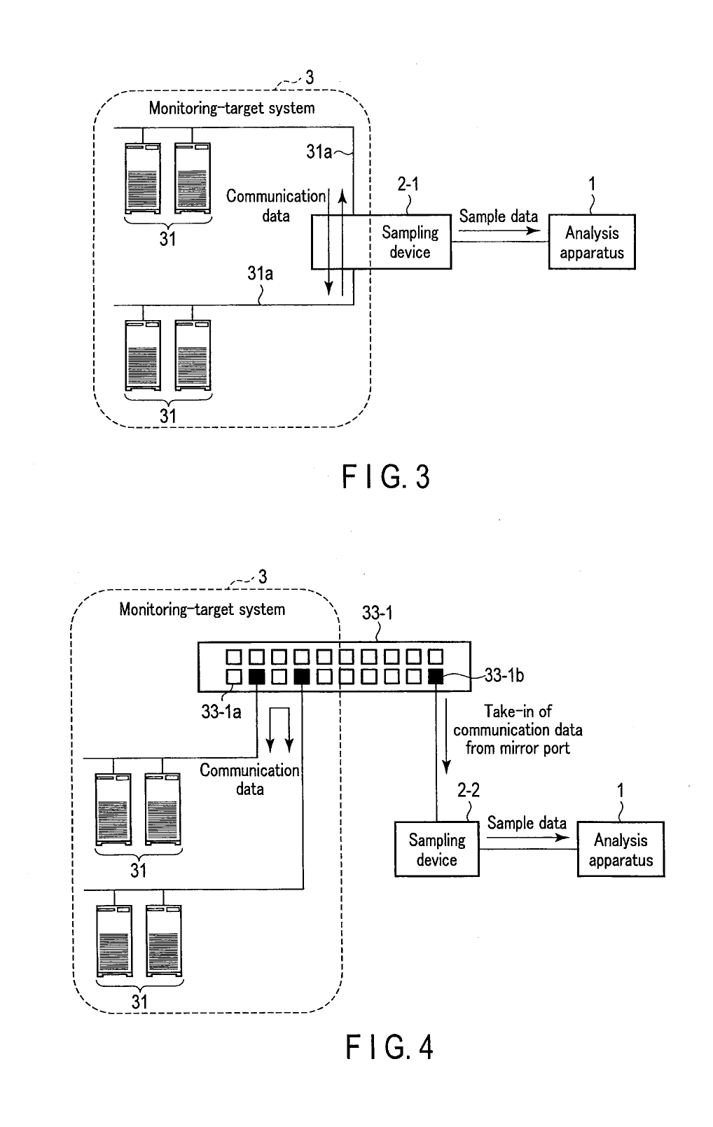

The sampling device 2-1 is connected in series to a communication cable of the network, and can sample communication data flowing in the communication cable. The sampling device 2-1 is connected to the firewall 32 in order to detect a security incident such as an attack from the outside via the external network 4. In addition, the sampling device 2-2, 2-3 is connected to the network 33, and can sample communication data flowing in the network switch 33. The details of the sampling of communication data by the sampling device 2-1, 2-2, 2-3 will be described later (see FIG. 3, FIG. 4).

Incidentally, although three sampling devices 2-1, 2-2 and 2-3 are provided in the configuration of FIG. 1, an arbitrary number of sampling devices may be disposed at respective locations of the network in accordance with, for example, the configuration of the monitoring-target system 3. The sampling device 2 may not only be connected in series to the communication cable with the firewall 32 or connected to the network switch 33-1, 33-2, but the sampling device 2 may also be disposed at other locations if the sampling device 2 can sample communication data flowing in the network in the monitoring-target system 3.

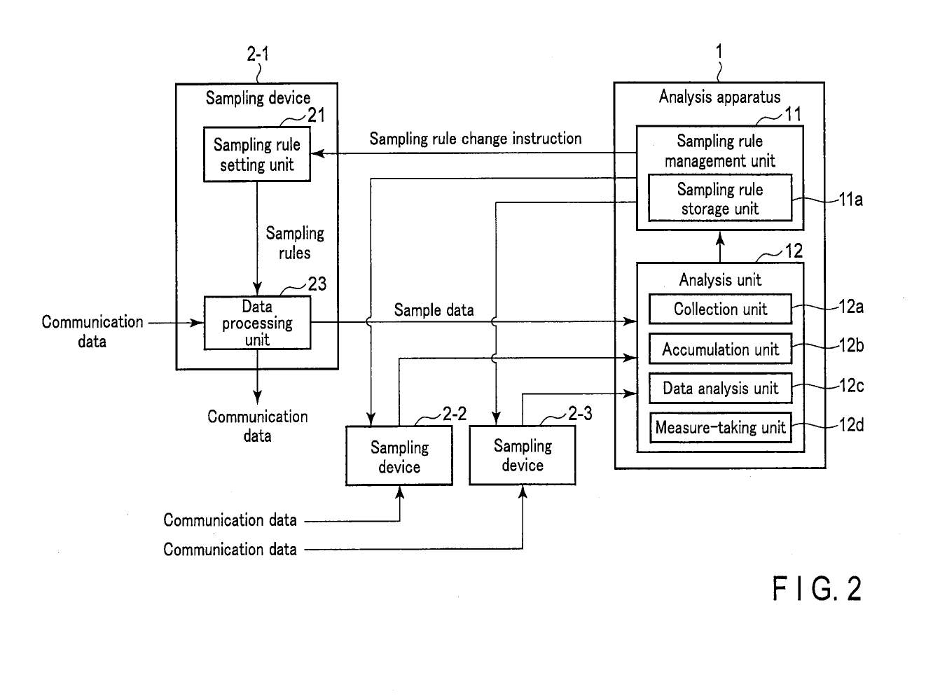

FIG. 2 is an exemplary block diagram illustrating a detailed functional configuration of the analysis apparatus 1 and sampling device 2-1 of the communication data analysis system in the embodiment.

As illustrated in FIG. 2, the analysis unit 12 of the analysis apparatus 1 includes a collection unit 12a which collects communication data (sample data) transmitted from the plural sampling devices 2-1, 2-2 and 2-3; an accumulation unit 12b which accumulates the sample data, which was collected by the collection unit 12a, in a storage medium provided in the analysis apparatus 1; a data analysis unit 12c which makes an analysis as to whether there is a possibility of occurrence of a security incident, with respect to the sample data accumulated by the accumulation unit 12b; and a measure-taking unit 12d which executes a process corresponding to an analysis result by the data analysis unit 12c. The data analysis unit 12c can determine, in association with each of the sampling devices 2-1, 2-2 and 2-3, whether there is a possibility of occurrence of a security incident, with respect to the communication data (sample data) sampled from the plural sampling devices 2-1, 2-2 and 2-3. When the data analysis unit 12c has determined that there is a possibility of occurrence of a security incident in the sample data, the measure-taking unit 12d outputs an alert, and causes the sampling rule management unit 11 to change the sampling rules of the sampling device 2 in accordance with the analysis result.

The sampling rule management unit 11 of the analysis apparatus 1 instructs the sampling device 2 to change the sampling rules, in accordance with the analysis result by the analysis unit 12. It is assumed that the sampling rule management unit 11 stores, for example, in a sampling rule storage unit 11a, data or the like in which sampling rules that are to be instructed to the sampling device 2 are defined in accordance with the analysis result by the analysis unit 12. For example, when it has been determined that there is a possibility of occurrence of a security incident with respect to the sample data collected from one sampling device 2, among the plural sampling devices 2-1, 2-2 and 2-3, the sampling rule management unit 11 may output a sampling rule change instruction to only the corresponding sampling device 2, or may output sampling rule change instructions to the plural sampling devices 2.

On the other hand, a data processing unit 23 of the sampling device 2-1 transmits data, which was sampled from the communication data, to the analysis apparatus 1 as sample data, according to the sampling rules which are set by a sampling rule setting unit 21. The data processing unit 23 determines, for example, a transmission item of data, a sampling rate of data, and transmission/non-transmission of data, according to the sampling rules, and transmits only necessary communication data (sample data) to the analysis apparatus 1.

The sampling rule setting unit 21 sets sampling rules for the data processing unit 23. When the sampling rule setting unit 21 has received a sampling rule change instruction from the sampling rule management unit 11 of the analysis apparatus 1, the sampling rule setting unit 21 can change the sampling rules according to the instruction, and can change the information amount of the sample data which is sampled by the data processing unit 23 and transmitted to the analysis apparatus 1.

Incidentally, assuming that the sampling devices 2-2 and 2-3 have the same function as the sampling device 2-1, a detailed description thereof is omitted.

Next, a description is given of the sampling of communication data by the sampling devices 2-1, 2-2 and 2-3.

FIG. 3 illustrates an example of disposition of the sampling device 2-1 shown in FIG. 1. As illustrated in FIG. 3, the sampling device 2-1 is connected in series to a communication cable 31a. The sampling device 2-1 determines data, which is to be transmitted to the analysis apparatus 1 according to the sampling rules, from among the communication data flowing in the communication cable, and transmits the determined data to the analysis apparatus 1 as sample data.

FIG. 4 illustrates an example of disposition of the sampling device 2-2 shown in FIG. 1. In the monitoring-target system 3, a plurality of information devices 31 are connected to a network which is connected to a port 33-1a of the network switch 33-1. The information device 31 transmits/receives communication data via the network switch 33-1. As illustrated in FIG. 4, the sampling device 2-2 is connected to a mirror port 33-1b of the network switch 33-1. The mirror port 33-1b is a port having a function of simultaneously sending communication data which the other port 33-1a transmits/receives in the network switch 33-1. The sampling device 2-2 takes in the communication data from the mirror port 33-1b, determines sample data from this communication data according to the sampling rules, and transmits the sample data to the analysis apparatus 1. Incidentally, like the sampling device 2-2, the sampling device 2-3 is connected to the network switch 33-2, takes in the communication data from the mirror port, and samples communication data meeting the sampling rules.

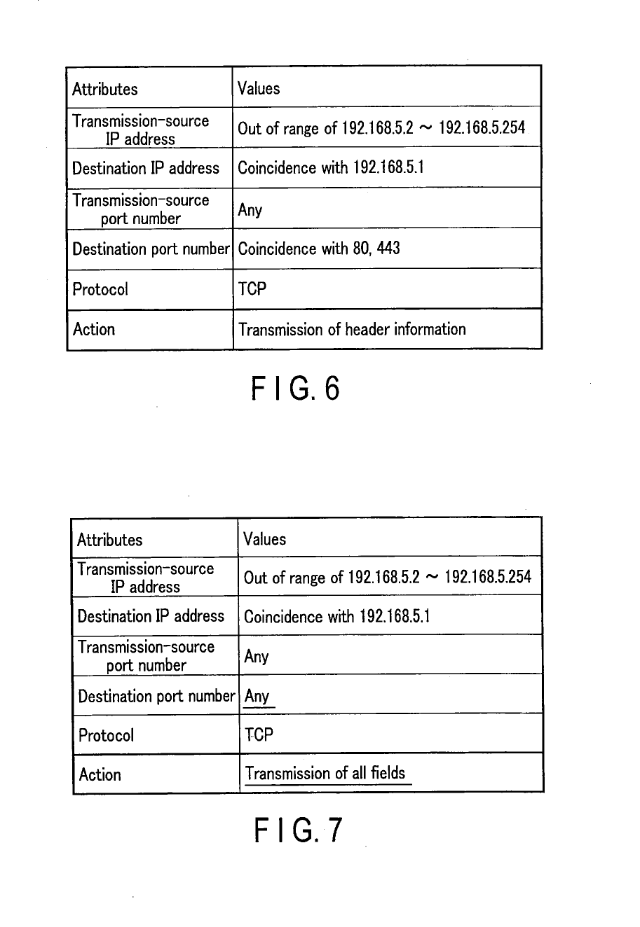

The sampling device 2-1, 2-2, 2-3 illustrated in FIG. 3 and FIG. 4 transmits, as sample data, only the necessary communication data meeting the sampling rules, among the communication data used in the monitoring-target system 3, to the analysis apparatus 1. The sampling rules indicate a condition for determining transmission to the analysis apparatus 1 or discard of communication data which is sampled by the sampling device 2-1, 2-2, 2-3, for example, based on a condition which is set for each of fields of the communication data. Attributes of rules set by the sampling rules are, for instance, “transmission-source IP address”, “destination IP address”, “transmission-source port number”, “protocol”, and “destination port number”. As regards each attribute, setting of, for example, coincidence, noncoincidence, or range destination, is possible (a concrete example of the sampling rules will be described later (FIG. 6, FIG. 7)).

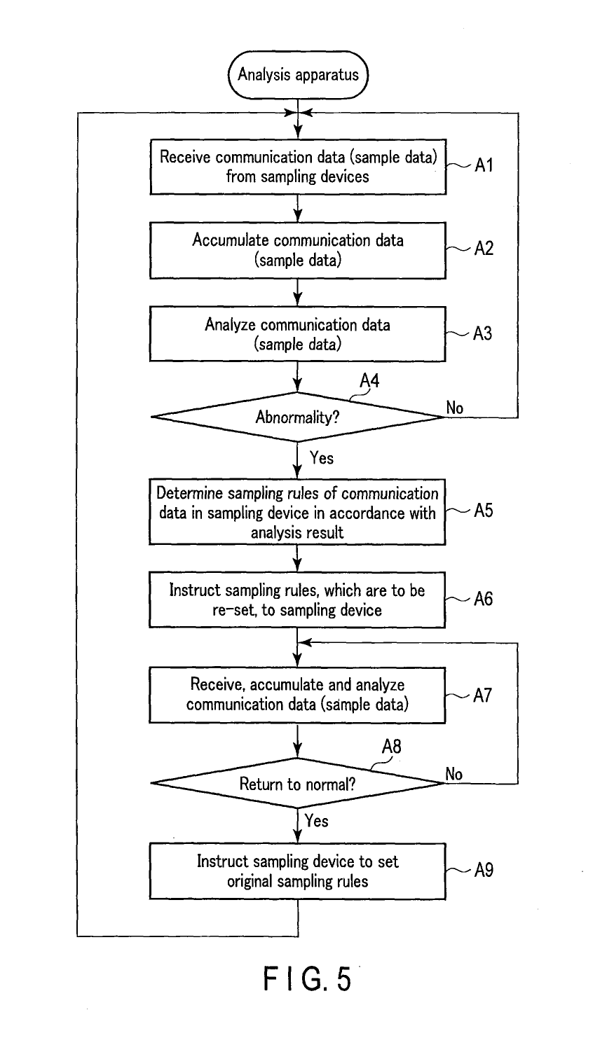

Next, the operation of the communication data analysis system in the embodiment is described. FIG. 5 is a flowchart illustrating the operation of the analysis apparatus 1 in the embodiment.

Each of the sampling devices 2-1, 2-2 and 2-3, which are disposed in the monitoring-target system 3, transmits only necessary data, from among communication data, to the analysis apparatus 1 as sample data according to the sampling rules. FIG. 6 illustrates a concrete example of the sampling rules which are set in the sampling device 2-1, 2-2, 2-3. Incidentally, the same sampling rules may be set for the plural sampling device 2-1, 2-2 and 2-3, or different sampling rules may be set in accordance with locations where the sampling device 2-1, 2-2 and 2-3 are disposed.

As illustrated in FIG. 6, the sampling rules are composed of values which are conditions for the respective attributes, and actions corresponding to the values. In the example of FIG. 6, it is indicated that, in the case of communication data in which “transmission-source IP address” does not coincide with “192.168.5.2˜192.168.5.254”, “destination IP address” coincides with “192.168.5.1”, “destination port number” is 80 or 443 and “protocol” is TCP, an “action” of transmitting only header information of the communication data to the analysis apparatus 1 as sample data is taken. The reason for narrowing down, in this manner, the data which is transmitted from the sampling device 2-1, 2-2, 2-3 to the analysis apparatus 1 is that if all communication data acquired by the sampling device 2 is transmitted from the sampling device 2 to the analysis apparatus 1, the amount of communication to the analysis apparatus 1 becomes enormous and accordingly the processing amount in the analysis apparatus 1 increases.

The analysis apparatus 1 receives the sample data, which is transmitted from each sampling device 2-1, 2-2, 2-3, by the collection unit 12a of the analysis unit 12 (step A1). The accumulation unit 12b accumulates the sample data which was received by the collection unit 12a (step A2).

The data analysis unit 12c detects a security incident by using preset rules, with respect to the sample data received from the sampling device 2-1, 2-2, 2-3. Specifically, when abnormal communication data, which is not assumed in normal use of the monitoring-target system 3, has occurred, the data analysis unit 12c suspects the occurrence of an attack or the like, and determines that there is a possibility of a security incident.

As a result of an analysis by the data analysis unit 12c, if it is determined that there is no possibility of a security incident (step A4, No), the analysis apparatus 1 receives sample data from the sampling device 2-1, 2-2, 2-3 in the same manner as described above, and continues an analysis of this sample data (steps A1 to A3).

On the other hand, as a result of an analysis by the data analysis unit 12c, if it is determined that there is a possibility of a security incident (step A4, Yes), the measure-taking unit 12d of the analysis unit 12 outputs an alert indicating that there is the possibility of a security incident, and instructs the sampling rule management unit 11 to change the sampling rules which are set in the sampling device 2.

Based on the analysis result in the data analysis unit 12c, the sampling rule management unit 11 determines the sampling rules in the sampling device 2 in order to strengthen the acquisition of communication data with respect to the sampling device 2 that is the source of sampling of the sample data that was determined to have the possibility of a security incident (step A5), and issues a change instruction to the sampling rule setting unit 21 of the sampling device 2 to change the sampling rules to the sampling rules that are to be re-set (step A6).

FIG. 7 illustrates an example of sampling rules to which the sampling rules shown in FIG. 6 have been changed. In the sampling rules illustrated in FIG. 7, the condition for “destination port number” is relaxed, and the communication data of all port numbers is set to be a target of transmission to the analysis apparatus 1. In addition, as regards “action”, such a change has been made that all fields including payload information of communication data are transmitted to the analysis apparatus 1, although only the header information of the communication data was previously sampled.

In this manner, by dynamically changing the sampling rules 22 in accordance with the instruction from the analysis apparatus 1, such advantageous effects can be obtained that the information amount of sample data, which is acquired from a location with a high possibility of occurrence of a security incident, can be increased, and the possibility of occurrence of a security incidence can more strictly be understood.

The analysis apparatus 1 receives from the sampling device 2 the sample data of the information amount which was increased by the change of sampling rules, and continues an analysis of the sample data in the same manner as described above (step A7).

After the passage of a predetermined time from the change of sampling rules of the sampling device 2, if it is determined by the analysis by the analysis unit 12 that there is no possibility of a security incident (step A8, Yes), the sampling rule management unit 11 of the analysis apparatus 1 issues once again a sampling rule change instruction to the sampling device 2. Thereby, an instruction is issued to restore the sampling rules to the original sampling rules which are usually set (step A9). Specifically, the sampling rules illustrated in FIG. 7 are changed to the sampling rules illustrated in FIG. 6.

In this manner, in the communication data analysis system in the first embodiment, when the communication data is transmitted from the sampling device 2 to the analysis apparatus 1, only the necessary communication data for the analysis in the analysis apparatus 1 can be transmitted to the analysis apparatus 1, in accordance with the sampling rules which are set in the sampling device 2. Specifically, only when it is determined that there is a possibility of a security incident, the sampling rules can dynamically be determined so that the sampling device 2, which transmitted the sample data for which this determination was made, increases the information amount of the sample data. Therefore, it is possible to perform effective security monitoring, while properly controlling the transmission amount of communication data from the sampling device 2 to the analysis apparatus 1.

### Second Embodiment

Next, a second embodiment is described. Assuming that the configuration of a communication data analysis system in the second embodiment is the same as the configuration illustrated in FIG. 1 in connection with the first embodiment, a detailed description thereof is omitted.

When sample data is transmitted from the sampling device 2 to the analysis apparatus 1, it is not practical to instantaneously transmit the data, which was sampled by the sampling device 2, to the analysis apparatus 1. Such implementation is thought that the sampled data is buffered in the sampling device 2 by a predetermined amount or for a predetermined time, and a certain amount of communication data is transmitted to the analysis apparatus 1. However, in this case, since the sampled data stays in the sampling device 2 for a predetermined time, such a problem arises that an analysis in the analysis apparatus 1 is not executed in real time. In the second embodiment, in order to solve this problem, the sample data transmission timing from the sampling device 2 to the analysis apparatus 1 is dynamically varied.

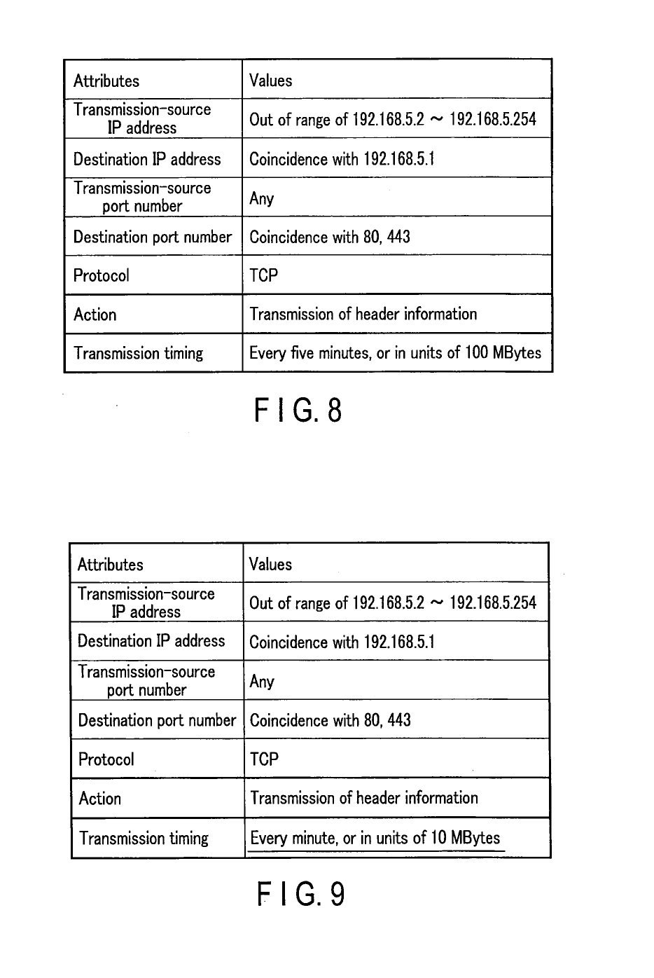

The basic operations of the analysis apparatus 1 and sampling device 2 in the second embodiment are the same as in the first embodiment. Different points from the first embodiment are the content of sampling rules which are set in the data processing unit 23 of the sampling device 2, and the content of the sampling rule change instruction from the sampling rule management unit 11 to the sampling rule setting unit 21. Specifically, as illustrated in FIG. 8, the sampling rules, which are set in the sampling device 2, are composed of “transmission timing” to the analysis apparatus 1, in addition to the values which are the conditions for the respective attributes, such as “transmission-source IP address”, “destination IP address”, “transmission-source port number”, “protocol” and “destination port number”, and the “action” corresponding to the values, which are the same as in the first embodiment.

In the example of the sampling rules illustrated in FIG. 8, it is indicated that, in the case of communication data in which “transmission-source IP address” does not coincide with “192.168.5.2˜192.168.5.254”, “destination IP address” coincides with “192.168.5.1”, “destination port number” is “80” or “443” and “protocol” is TCP, an “action” of transmitting header information of the communication data to the analysis apparatus 1 as sample data is taken. In addition, the “transmission timing” of sample data indicates that the sample data is transmitted in every five minutes, or when the data amount buffered in the sampling device 2 has reached 100 MBytes.

The sampling device 2 samples and buffers communication data according to the sampling rules, and transmits the data, which was buffered at the timing according to the “transmission timing” of the sampling rules, to the analysis apparatus 1 as sample data.

In this manner, the analysis apparatus 1 collects the communication data which was sent from the sampling device 2 at the “transmission timing” that is set in the sampling rules, and a security incident is detected by the analysis unit 12 by using preset rules.

When the analysis unit 12 of the analysis apparatus 1 has determined that there is a possibility of a security incident, the sampling rule management unit 11 issues a sampling rule change instruction to the sampling rule setting unit 21 of the sampling device 2 in order to strengthen the communication data acquisition from the sampling device 2 which is the transmission source of the sample data that is the target of analysis.

Specifically, the sampling rules illustrated in FIG. 8 are changed to sampling rules in which “transmission timing” was changed as illustrated in FIG. 9. In the sampling rules illustrated in FIG. 9, it is indicated that the frequency of transmission of sample data is set such that the sample data is transmitted in every minute or when the data amount buffered in the sampling device 2 has reached 10 MBytes. Specifically, the sampling rules are changed so as to increase the frequency of transmission of sample data.

In this manner, by dynamically changing the sampling rules, which are set in the sampling device 2, in accordance with the instruction from the analysis apparatus 1, the delay in acquisition of information, which is acquired from a location with a high possibility of occurrence of a security incident, can be made shorter, and a security incident can advantageously be detected in a manner closer to real-time detection.

After the passage of a predetermined time from the change of sampling rules of the sampling device 2, if it is determined that there is no possibility of a security incident with respect to the sample data from the sampling device 2, the sampling rule management unit 11 of the analysis apparatus 1 issues once again a sampling rule change instruction. Thereby, the sampling rules illustrated in FIG. 9 are restored to the usual sampling rules illustrated in FIG. 8.

Incidentally, in the above-described second embodiment, the example, in which two conditions, namely the time interval and the data amount, are used as the transmission timing, has been illustrated. However, either of the two conditions may be used.

In addition, in the first and second embodiments, the sampling rules are changed for the sampling device 2 which transmitted the sample data that was determined to have a possibility of occurrence of a security incident. However, the sampling rules may be changed for a plurality of sampling devices. For example, when it has been determined that there is a possibility of occurrence of a security incident, by an analysis of sample data received from the sampling device 2-1, the sampling rules of the sampling device 2-1 are changed as described above, and the information amount of communication data that is transmitted from the sampling device 2-1 to the analysis apparatus 1 is increased. On the other hand, the sampling rules are changed for the other sampling devices 2-2 and 2-3 so as to decrease the information amount of communication data which is transmitted to the analysis apparatus 1. Thereby, since it is possible to prevent a large increase in the whole information amount which is transmitted from the sampling devices 2-1, 2-2 and 2-3 to the analysis apparatus 1, it is also possible to prevent a large increase in the processing load in the analysis apparatus 1.

In addition, when a possibility of occurrence of a security incident has been detected, if a temporary increase in information amount from the sampling devices 2-1, 2-2 and 2-3 to the analysis apparatus 1 is allowable, the sampling rules may be changed for not only the sampling device 2-1 but also the sampling devices 2-2 and 2-3 so as to increase the information amount of communication data which is transmitted to the analysis apparatus 1. Thereby, it is possible to properly cope with the possibility of occurrence of a security incident.

In the above description, the first embodiment and second embodiment are individually described, but these embodiments can be implemented in combination. For example, a sampling device 2, which transmits sample data to the analysis apparatus 1 according to the first embodiment, and a sampling device 2, which transmits sample data to the analysis apparatus 1 according to the second embodiment, may be mixedly present in the plural sampling devices 2.

Additionally, in the above description, the communication data flowing in the network of the monitoring-target system 3 is sampled. However, other communication data, which can be sampled in the monitoring-target system 3, may be transmitted to the analysis apparatus 1 as sample data. For example, it is possible to transmit log data, which is recorded by the firewall 32 (or IPS (Intrusion Prevention System)), or flow information, which is recorded by, e.g. a traffic monitoring tool that monitors the condition of use of the network, to the analysis apparatus 1 as sample data that is the target of analysis in the analysis apparatus 1. In this case, it is assumed that the analysis apparatus 1 includes a function which can analyze the log data or flow information that is transmitted from the sampling device 2, and the analysis apparatus 1 can change the sampling rules in the sampling device 2 in accordance with the analysis result in the same manner as described above. Besides, the sampling device 2, which samples the log data or communication flow, can be provided as a device assembled in the firewall 32 or information device 31 included in the monitoring-target system 3, or as a function realized by executing a communication data analysis program in the firewall 32 or information device 31.

In this manner, in the analysis system in the embodiment, when communication data is transmitted from the sampling device 2 to the analysis apparatus 1, the transmission/non-transmission of data, the transmission item of data and the frequency of transmission of data are determined according to the sampling rules which are set in the sampling device 2, and only necessary data can be transmitted to the analysis apparatus 1. The sampling rules can be dynamically determined by the instruction from the analysis apparatus 1. The analysis apparatus 1 analyzes the possibility of occurrence of a security incident in the monitoring-target system 3, based on the communication data (sample data) acquired from the sampling device 2, and dynamically changes the setting of sampling rules so that the communication data of a location with a high possibility of occurrence of a security incident can be intensively collected.

By dynamically changing the setting of sampling rules in this manner, the data can be intensively collected with respect to the location which was determined to have a high possibility of occurrence of a security incident, while the data amount that is transmitted to the analysis apparatus 1 is suppressed to be small. Therefore, an efficient analysis of a security incident can be realized.

The method that has been described in connection with each of the above embodiments may be stored as a computer-executable program in a storage medium such as a magnetic disk (e.g. a flexible disk, a hard disk), an optical disk (e.g. a CD-ROM, a DVD), a magneto-optic disc (MO), or a semiconductor memory, and may be distributed.

Additionally, the storage form of this storage medium may be any form as long as the storage medium can store programs and is readable by a computer.

Additionally, an OS (operating system) running on a computer based on an instruction of a program installed from the storage medium into the computer, or MW (middleware), such as database management software or network software, may execute a part of each of processes for realizing the above embodiments.

Additionally, the storage medium in each embodiment is not limited to a medium which is independent from the computer, and includes a storage medium which stores or temporarily stores, by download, a program which is transmitted over a LAN or the Internet.

Additionally, the number of storage media is not limited to one. The configuration of the storage media in the invention includes such a case that the process in each of the above-described embodiments is executed from a plurality of media, and the configuration of the media may be any configuration.

Incidentally, the computer in each embodiment is a computer which executes each process in each embodiment, based on a program stored in the storage medium. The computer may have any configuration, for example, a configuration as a single apparatus such as a personal computer, or a configuration as a system in which a plurality of apparatuses are connected over a network.

Additionally, the computer in each embodiment is a general concept including an arithmetic processing apparatus included in information processing equipment, a microcomputer, etc., which can realize the functions of the invention by programs.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An analysis system comprising a sampling device disposed in a network in a monitoring-target system, and an analysis apparatus configured to analyze a possibility of occurrence of a security incident, based on communication data sampled by the sampling device,
the sampling device comprising:
a transmission unit configured to transmit sample data meeting a rule of data sampling, among the communication data of the network, to the analysis apparatus; and
a sampling rule setting unit configured to set the rule in accordance with an instruction from the analysis apparatus, and
the analysis apparatus comprising:
a sampling rule management unit configured to instruct the sampling device to change the rule in accordance with an analysis result, when it is determined that there is the possibility of occurrence of a security incident, as a result of an analysis of the sample data transmitted by the transmission unit.

2. The analysis system of claim 1, wherein the sampling rule management unit is configured to instruct the sampling device to change a rule indicating a range of the communication data which is set as the sample data.

3. The analysis system of claim 1, wherein the sampling rule management unit is configured to instruct the sampling device to change a rule indicating a timing of transmission of the sample data by the transmission unit.

4. The analysis system of claim 1, wherein a plurality of the sampling devices are disposed in the monitoring-target system, and
the sampling rule management unit is configured to instruct the plurality of sampling devices to change the rule in accordance with the analysis result.

5. An analysis apparatus comprising:
an analysis unit configured to analyze a possibility of occurrence of a security incident, based on communication data received from a sampling device disposed in a network in a monitoring-target system; and
a sampling rule management unit configured to instruct the sampling device to change a rule for transmission of the communication data in accordance with an analysis result, when it is determined that there is the possibility of occurrence of a security incident, as a result of an analysis of the communication data by the analysis unit.

6. A non-transitory computer-readable storage medium storing computer-executable instructions that, when executed, cause a computer to:
analyze a possibility of occurrence of a security incident, based on communication data received from a sampling device disposed in a network in a monitoring-target system; and
instruct the sampling device to change a rule for transmission of the communication data in accordance with an analysis result, when it is determined that there is the possibility of occurrence of a security incident, as a result of an analysis of the communication data.

7. The storage medium of claim 6, wherein the computer-executable instructions cause the computer to:
instruct the sampling device to change a rule indicating a range of the communication data which is set as the sample data.

8. The storage medium of claim 6, wherein the computer-executable instructions cause the computer to:
instruct the sampling device to change a rule indicating a timing of transmission of the sample data.

9. The storage medium of claim 6, wherein the computer-executable instructions cause the computer to:
instruct a plurality of the sampling devices to change the rule in accordance with the analysis result.
